(19) United States
(12) Patent Application Publication
(10) Pub. No.: US 2024/0246733 A1
(43) Pub. Date: Jul. 25, 2024

(54) FREE FLOW FILTER BOTTLE

(71) Applicant: The Coleman Company, Inc., Wichita, KS (US)

(72) Inventors: Jun Wang, Buffalo Grove, IL (US); John Lian, Guangzhou (CN)

(21) Appl. No.: 18/561,398

(22) PCT Filed: May 27, 2022
(86) PCT No.: PCT/US22/72611

§ 371 Date: Nov. 16, 2023

Related U.S. Application Data
(60) Provisional application No. 63/195,944, filed on Jun. 2, 2021.

(51) Int. Cl. B65D 51/24; A45F 3/16; C02F 1/00

(52) U.S. Cl. CPC B65D 51/242; A45F 3/16; C02F 1/003; A45F 2003/163; C02F 2307/02

(57) ABSTRACT

A bottle is provided that incorporates a free flow filter that can passively filter water by the action of gravity as a user drinks from the bottle. The bottle uses an umbrella valve to vent air from the filter into the body of the bottle so that a continuous stream of filtered water is provided by the bottle as water is poured from the bottle. In an embodiment, the umbrella valve moves from a closed position to an open position when at least a threshold pressure is applied to a diaphragm of the valve. When in the open position, air may vent from the filter and into the body of the bottle.

### CROSS-REFERENCE TO RELATED APPLICATIONS

This application claims priority to U.S. Provisional Patent Application Ser. No. 63/195,944, filed on Jun. 2, 2021, entitled “FREE FLOW FILTER WATER BOTTLE,” currently pending, the entire disclosure of which is incorporated herein by reference.

### FIELD OF INVENTION

The present invention relates generally to a water bottle filter, and more particularly to a water bottle filter that filters water as a user pours water from the bottle.

### BACKGROUND OF INVENTION

It is challenging for consumers to filter water “on the go.” As such, some consumers purchase bottled water or resort to drinking unfiltered tap water. Bottled water purchased from stores is expensive and environmentally wasteful, and the bottles are thrown away after just one use. On the other hand, unfiltered tap water may contain chemicals and particulates that give the water an unpleasant taste or may be harmful.

To give consumers access to filtered water on the go, manufacturers developed reusable water bottles incorporating water filters. Typically, these bottles are provided as squeeze bottles or, alternatively, as bottles with a straw. Both types of bottles present issues for users.

Squeeze-style bottles require that the user squeeze the outside surface of the bottle to force water through the filter and out of the bottle. Unfortunately, people with limited hand strength cannot squeeze the bottle with enough force to drive water through the filter and out of the bottle. Also, it is extremely difficult, if not impossible, to maintain a continuous flow of water out of the bottle.

Straw-style bottles require a straw be used to draw water through the filter and out of the bottle. Straws are inconvenient since they must be periodically cleaned and can be misplaced when taken out of the bottle. Further, people with limited lung capacity may not be able to draw water through the filter and up the straw, preventing them from being able to adequately use the bottle.

### SUMMARY OF THE INVENTION

The present invention overcomes many of the shortcomings and limitations of the prior art devices discussed above. The invention described includes several embodiments of a free flow filter water bottle (referred to hereinafter as a “bottle”). The bottle includes a free flow filter (referred to hereinafter as a “filter”) that may passively filter water as the user drinks or pours water from the bottle. More specifically, the force of gravity is sufficient to cause water to flow through the filter and out of the bottle.

The filter may include a filter core retained within a filter housing. As water passes through the filter core, the filter core may capture chemicals and particulates present in the water. The filter core may be composed of carbon fibers (or other materials known in the art) that help remove chlorine, particulates, and other substances from the water. Water may flow into the filter core by passing through apertures located on the filter housing that extend therethrough.

Filtered water may be poured from the bottle simply by the user tipping the bottle to drink therefrom. An umbrella valve may facilitate the smooth flow of water from the bottle. The umbrella valve may be attached to a cap within the filter housing and may vent air from the filter and into the bottle as the user drinks from the bottle.

Initially, when the bottle's opening is tilted downwardly, gravity may draw water out of the bottle. As water exits the bottle, air may flow into the bottle and into the filter where it may be trapped within the filter by the umbrella valve. As air continues to flow into the bottle, the force exerted on the umbrella valve by the air may increase until the force exceeds a threshold value. When the force exceeds the threshold value, the umbrella valve preferably opens. Once the umbrella valve opens, the air in the filter may vent into the interior of the bottle, equalizing the air pressure inside and outside of the bottle. This venting process (and the corresponding air pressure equalization) may allow water to flow from the bottle in a continuous stream. As water exits the bottle and air vents into the interior of the bottle, water may pass through the apertures of the filter housing, through the filter, and out of the bottle.

From time to time, as the user continues to pour water from the bottle, the force applied to the umbrella valve by the air may drop below the threshold value. When the force drops below the threshold value, the umbrella valve may close. The umbrella valve may re-open once the force from the air inside the filter again exceeds the threshold value. As the umbrella valve opens and closes, water may continuously flow through the filter and out of the bottle.

The above-described process may continue until the user stops pouring water from the bottle or the bottle is emptied of water. After water stops pouring from the bottle, air may no longer enter the filter, and the umbrella valve may close, thus no longer venting air into the bottle's interior.

These and other aspects and advantages of the present invention will become apparent to those skilled in the art after considering the following detailed description in connection with the accompanying drawings.

### BRIEF DESCRIPTION OF DRAWINGS

FIG. 1 is an isometric view of a water bottle and a free flow filter (the free flow filter illustrated within and outside of the water bottle) constructed according to the teachings hereof;

FIG. 2 is an exploded view of the free flow filter of FIG. 1;

FIG. 3 is an isometric view of an umbrella valve of the free flow filter of FIG. 2 inserted into a cap;

FIG. 4 is an isometric side view of the umbrella valve of FIG. 2;

FIG. 5 is an isometric bottom view of the cap of FIG. 3;

FIG. 6 is a cross-sectional view of the free flow filter of FIG. 1 inserted into the water bottle of FIG. 1; and

FIG. 7 is an isometric view of the free flow filter and the water bottle of FIG. 1.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

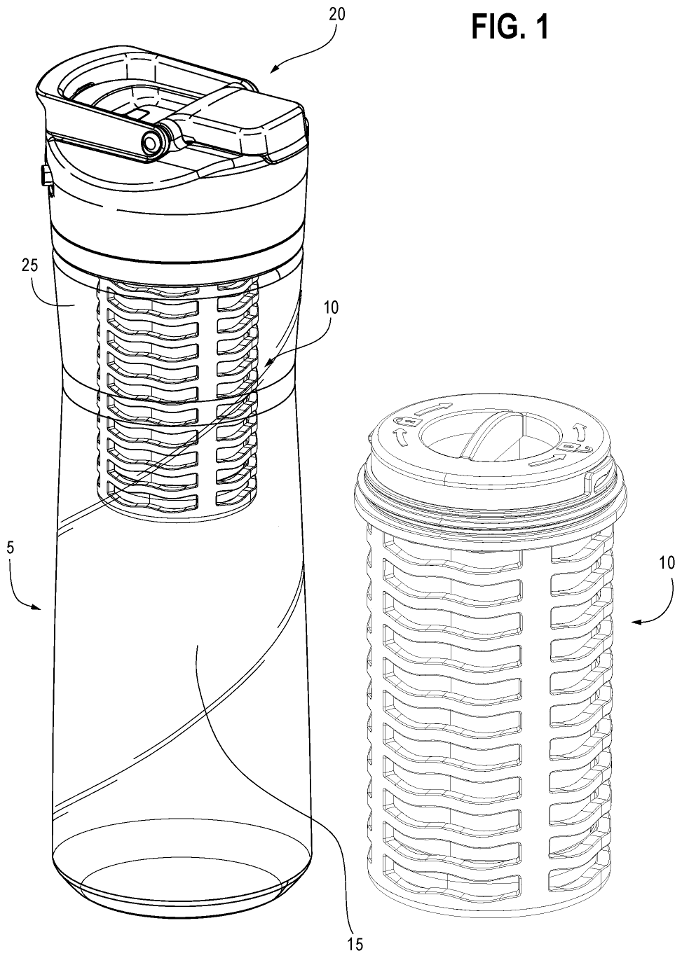

FIG. 1 illustrates a bottle 5 and a filter 10 that may be used to passively filter water as a user drinks from the bottle 5. As described below, when the filter 10 is used, it may be secured within the bottle 5.

The bottle 5 may be composed of a body 15 and a lid 20 that is releasably attachable to the body 15. The body 15 may be provided in the form of a hollow cylinder with thin sidewalls such that the bottle 5 may hold a fluid (including, but not limited to, water). The body 15 may be composed of a resilient waterproof material, e.g. plastic. The body 15 may also have a top portion 25 to which the lid 20 may be affixed. In alternative embodiments, the bottle 5 may take on a nearly limitless number of known and reasonably foreseeable alternative shapes and constructions.

The lid 20 may be provided in the form of a cylinder, though other shapes are foreseeable. When the lid 20 is affixed to the top portion 25, the lid 20 may help prevent liquid from spilling from the bottle 5 when the bottle 5 is being used or is otherwise tipped over. The diameter of the lid 20 may be substantially the same as, or slightly larger than, the top portion 25 such that the lid 20 may be affixed to the top portion 25 by screwing the lid 20 onto the top portion 25, by a friction fit, or by other methods as would be appreciated by those skilled in the art. Similarly, the lid 20 may be removed from the top portion 25 by a twisting motion or a pulling motion. When the lid 20 is removed from the bottle 5, the user may fill the bottle 5 with water as desired.

The filter 10 may be provided in the form of a cylinder. The diameter of the filter 10 is smaller than the diameter of the body 15 so that the filter 10 may be housed within the bottle 5. When inserted into the bottle 5, the filter 10 may use known or reasonably foreseeable methods and substances to remove chemicals and particulates from water passing through the filter 10 (e.g. chlorine and dissolved solids). Once the filter 10 has reached the end of its useful life, the user may remove the filter 10 from the bottle 5 and replace it with another filter.

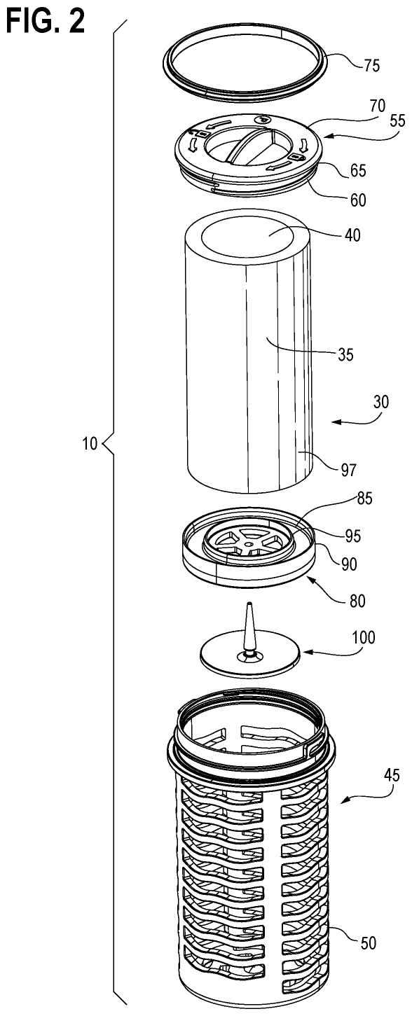

Turning to FIG. 2, the filter 10 may include a filter core 30 having a body 35. The body 35 is illustrated in the shape of a cylinder, though other shapes are foreseeable. The filter core 30 may have a channel 40 that extends through the length of the body 35. When a user drinks from the bottle 5, water may permeate through the body 35 of the filter core 30 and into the channel 40. The body 35 is preferably composed of a material that may filter chlorine, particulates, and other substances out of the water as the water travels through the body 35, such as carbon fibers.

A filter housing 45 may surround the filter core 30 to help protect the filter core 30. The filter housing 45 may be provided in the shape of a hollow cylinder with a diameter somewhat larger than the diameter of the filter core 30. The filter housing 45 may have a plurality of apertures 50 that extend through its surface such that water within the bottle 5 may flow freely into and out of the filter housing 45, and thus, freely to and from the filter core 30.

A filter adapter 55 may also be provided, generally in the form of a cylinder. The filter adapter 55 may be used to selectively attach the filter 10 to a lid such as the lid 20 (not illustrated). A bottom portion 60 of the filter adapter 55 may be narrower than a middle portion 65. The bottom portion 60 may attach to the filter core 30 and the middle portion 65 may attach to the filter housing 45. The middle portion 65 may be affixed to the filter housing 45 by glue, threads, or other attachment means that would be known to those in the art. A top portion 70 of the filter core 30 may be affixed to the lid 20 in a number of ways including but not limited to a threaded engagement or a friction fit.

An O-ring 75 may be provided in the shape of a thin ring and may be affixed to the top portion 70 of the filter adapter 55. The O-ring 75 may be composed of silicone or another flexible, waterproof material. The O-ring 75 may help create a waterproof seal between the filter adapter 55 and the lid 20 when the filter adapter 55 is affixed to the lid 20. The seal may help prevent leakage of filtered water into the body 15 of the bottle 5 and/or leakage of unfiltered water into the lid 20 as the user drinks from the bottle 5.

A cap 80 may be provided for attachment to the filter core 30 in the form of a circular body 85 with thin sidewalls. Two concentric circular wall members, a first wall member 90 and a second wall member 95, may protrude upwardly from the circular body 85. The diameter of the first wall member 90 may be substantially the same as, or just larger than, the diameter of the filter core 30. The diameter of the second wall member 95 may be substantially the same as, or just smaller than, the diameter of the channel 40. Thus, a bottom portion 97 of the filter core 30 may be received by the cap 80 and retained between the wall members 90, 95. The filter core 30 may be affixed to the cap 80 via a friction fit, glue, or by other methods that would be known or foreseeable in the art.

A valve, provided here as an umbrella valve 100, is preferably engageable with the cap 80. The umbrella valve 100 may be composed of a flexible, waterproof material, such as silicone The umbrella valve 100 may allow air to vent from the filter 10 as the user drinks from the bottle 5. More particularly, the umbrella valve 100 may allow for water to flow freely through the filter 10 and out of the bottle 5 as a user drinks from the bottle 5.

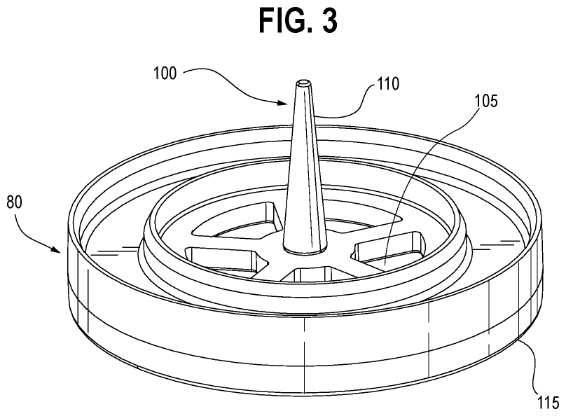

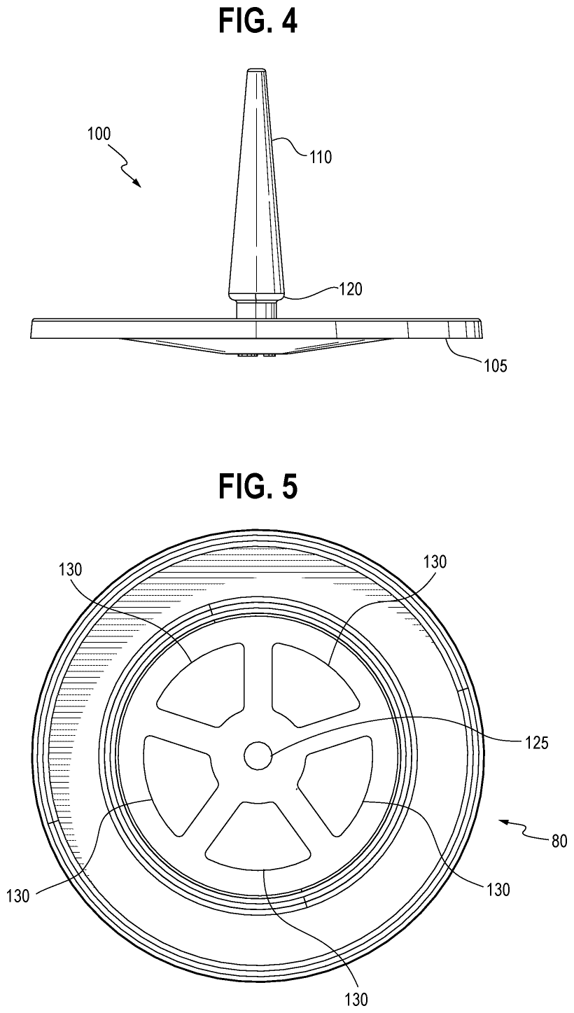

In FIG. 3, the umbrella valve 100 is illustrated as received within the cap 80 in a closed position, which may occur when the bottle 5 is not in use. The umbrella valve 100 preferably includes a diaphragm 105 (see FIG. 4) and a stem 110 that extends upwardly from the diaphragm 105. The stem 110 may be a thin, tapered cone shape that is affixed to, or integrally formed with, the diaphragm 105. The stem 110 of the umbrella valve 100 may be received into the cap 80 when the umbrella valve 100 and the cap 80 are coupled to one another. When the umbrella valve 100 is received by the cap 80, the diaphragm 105 may abut a bottom surface 115 of the cap 80. When the umbrella valve 100 is in the closed position, the diaphragm 105 may create a seal with the bottom surface 115 such that the flow of air through the cap 80 is impeded. More specifically, the umbrella valve 100 may be adapted to prevent air from venting through the cap 80. The umbrella valve 100 may remain in the closed position until the force exerted on the diaphragm 105 exceeds a threshold value, as described below.

The diaphragm 105 may have a flexible, thin body and a convex shape (with the stem 110 projecting upwardly from the inwardly curved portion of the diaphragm 105). The diaphragm 105 may retain this convex shape unless a force is exerted on the diaphragm 105 that exceeds the threshold value, as described below.

A knob 120 may be provided on the stem 110 of the umbrella valve 100. The knob 120 may be a protrusion having a larger diameter than other portions of the stem 110. When the umbrella valve 100 is received in the cap 80, the knob 120 may help keep the umbrella valve 100 from being dislodged from the cap 80 as air vents through the cap 80 while the bottle 5 is being used.

As illustrated in FIG. 5, the cap 80 may have a first aperture 125 and a plurality of second apertures 130 that extend through its surface. The aperture 125 may be circular and disposed of at or near the center of the cap 80. The aperture 125 may receive the stem 110 of the umbrella valve 100 when the umbrella valve 100 is engaged to the cap 80. The apertures 130 may be placed radially distally relative to the aperture 125. The apertures 130 may allow for air to vent through the cap 80, and thus from the filter 10 (not illustrated), as the user drinks from the bottle 5.

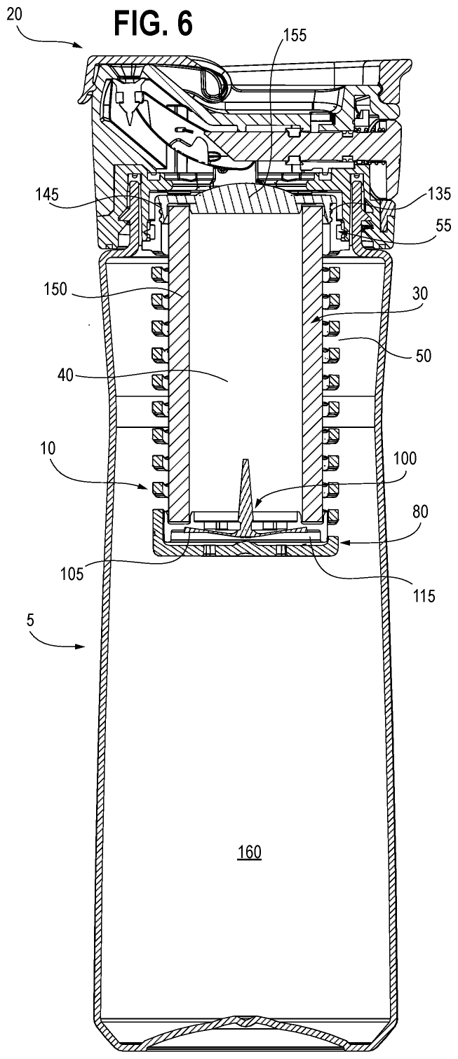

Turning to FIG. 6, the filter 10 may be attached to the lid 20 of the bottle 5 via the filter adapter 55. The filter adapter 55 may have threads 135 that allow for the filter adapter 55 to be coupled to corresponding threads on the lid 20 (not illustrated). The filter adapter 55 may be received into the lid 20 by turning the filter adapter 55 in a first direction as an upward force is applied on the filter adapter 55. Then, the filter adapter 55 may be removed from the lid 20 by turning it in a second direction as a downward force is applied on the filter adapter 55. In alternative embodiments, the filter adapter 55 may be attached to the lid 20 by a friction fit or by other means that would be appreciated by those skilled in the art.

The filter adapter 55 may also include flanges 145 that may receive a top section 150 of the filter core 30 and further help secure the filter core 30 within the filter adapter 55 via a friction fit. Further, the filter adapter 55 may have a bore 155 extending through its center portion that may align with the channel 40 of the filter core 30 so that water may flow from the channel 40 and out of the lid 20 when the user drinks from the bottle 5.

When the user wishes to pour or drink water from the bottle 5, the user may open the lid 20 using a known mechanism and tilt the bottle 5 toward their mouth. As water pours from the bottle 5 due to the force of gravity, air pressure within the bottle 5 may drop as air within an interior 160 of the bottle 5 expands to occupy the space vacated by the water leaving the bottle 5. The pressure differential between the interior 160 and the surrounding atmosphere allows air from the atmosphere to enter the bottle 5 via the lid 20. More particularly, air entering the bottle 5 travels from an opening in the lid 20, through the bore 155, and into the channel 40. Eventually, the air flows through the channel 40 and to the cap 80.

Initially, when air first enters the bottle 5 during the above-described process, the umbrella valve 100 may be in the closed position. Thus, the air that is trapped within the filter 10 during use may exert a force on the diaphragm 105. As the user continues to pour water out of the bottle 5, additional air may enter the bottle 5 and the force exerted by the air on the diaphragm 105 may increase. Eventually, the force applied by the air to the diaphragm 105 may exceed the threshold value, and the umbrella valve 100 may move into an open position. When the umbrella valve 100 is in the open position, the diaphragm 105 may lift away from the bottom surface 115 of the cap 80 and air may flow through the space created between the diaphragm 105 and cap 80. In effect, when the umbrella valve 100 opens, air may flow around the diaphragm 105 and into the interior 160 of the bottle 5.

From time to time, as the user pours water from the bottle 5, the force applied by the air to the umbrella valve 100 may drop below the threshold value, and the umbrella valve 100 may return to the closed position. The umbrella valve 100 may re-open once the force exerted by the air inside the filter 10 exceeds the threshold value, which in turn may allow air to vent out of the filter 10 and into the interior 160 of the bottle 5. This process may repeat itself during use.

As air vents into the interior 160 of the bottle 5, and as the user continues to pour water out of the bottle 5, water may flow into the filter 10. First, the water may flow from the interior 160, through the filter housing 45 via the apertures 50, and through the filter core 30. As the water travels through the filter core 30, it is preferably at least partially cleansed of chemicals and particulates. After passing through the filter core 30, the water travels into the channel 40 and to the filter adapter 55. Finally, the water flows out of the bottle 5 via the bore 155 and the opening in the lid 20.

The venting of the air facilitated by the umbrella valve 100 may allow for the bottle 5 to provide a continuous stream of water as the user pours water from the bottle 5. Then, once the user finishes pouring water from the bottle 5, the force exerted on the diaphragm 105 by the air may drop below the threshold value, and the umbrella valve 100 may return to the closed position.

In one embodiment, when the air pressure within the filter 10 reaches or exceeds five kilopascals (kPa), the force applied by the air to the diaphragm 105 may exceed the threshold value and the umbrella valve 100 may open. In other embodiments, the umbrella valve 100 may open when the air pressure within the filter 10 is at or near five kPa. In yet other embodiments, the umbrella valve 100 may open when the air pressure within the filter 10 is within a defined range of values.

The threshold value of force that may open the umbrella valve 100 may be adjusted by altering characteristics of the umbrella valve 100. For example, the flexural modulus of the diaphragm 105 may be altered by constructing the diaphragm 105 out of either a more rigid material or a softer material. A softer material, as compared to a more rigid material, may have a lower flexural modulus, which in turn may decrease the threshold value. Alternatively, the threshold value may be adjusted by altering the diameter of the diaphragm 105. As the diameter of the diaphragm 105 increases, the threshold value may decrease. In some embodiments, the diameter of the diaphragm 105 may be no larger than the diameter of the cap 80.

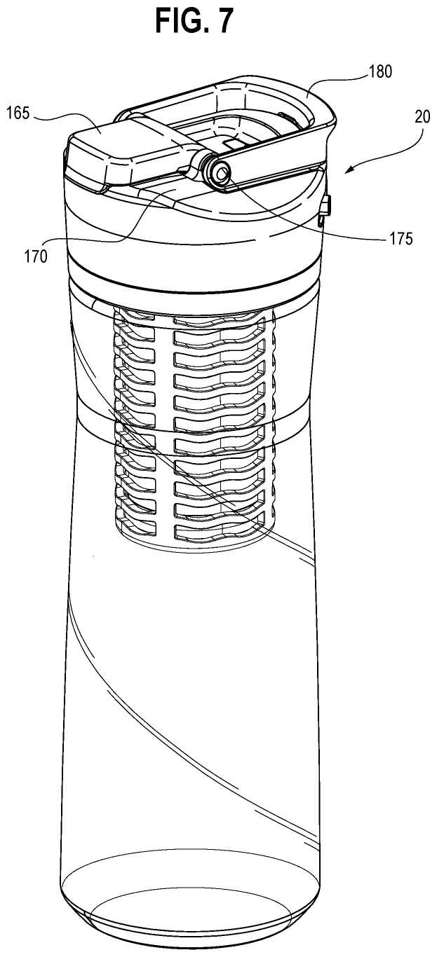

Turning to FIG. 7, a latch member 165 is affixed to an outside surface 170 of the lid 20. The user may open the lid 20 by rotating the latch member 165 away from the surface 170. The latch member 165 may be attached to the lid 20 by screws 175 or other rotatable attachment mechanisms that would be appreciated by those skilled in the art.

The lid 20 may also have a handle 180. The handle 180 may be attached to the surface 170 of the lid 20 by the screws 175 or other rotatable attachment mechanisms that would be appreciated by those skilled in the art. The handle 180 may be U-shaped to allow the user to easily carry the bottle 5 from place to place. The handle 180 may also be provided in the form of a ring or other similar shapes as would be appreciated by those skilled in the art.

As is evident from the foregoing description, certain aspects of the present invention is not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations and other uses in applications which do not depart from the spirit and scope of the present inventions are deemed to be covered by the inventions which are limited only by the claims which follow.

1. A bottle comprising:
a filter core selectively engageable with the bottle;
an umbrella valve engageable with the filter core; and
wherein when liquid is poured from an opening in the bottle and a threshold pressure is applied to the umbrella valve, the umbrella valve vents air from the filter core into an interior of the bottle.

2. The bottle of claim 1, the bottle further including a filter housing in which the filter core is retained.

3. The bottle of claim 2, the filter housing further including a plurality of apertures that places the filter core in fluid communication with an interior of the bottle.

4. The bottle of claim 1, wherein the filter core is coupled to a lid of the bottle such that water flows through the filter core when water is poured from the bottle.

5. The bottle of claim 1, wherein the umbrella valve is received within a cap coupled to a bottom portion of the filter core.

6. The bottle of claim 1, wherein the umbrella valve further comprises a diaphragm adapted to vent air into the interior of the bottle when the threshold pressure is applied to the umbrella valve.

7. The bottle of claim 6, wherein when a pressure lower than the threshold pressure is applied to the umbrella valve, the diaphragm of the umbrella valve abuts a cap, and when the threshold pressure is applied to the umbrella valve, at least a portion of the diaphragm does not abut the cap.

8. A bottle comprising:
a lid selectively engageable with a body of the bottle;
a filter core selectively couplable with the lid;
an umbrella valve coupled to the filter core, the umbrella valve including a diaphragm, and
wherein, when a pressure lower than a threshold pressure is applied to the diaphragm of the umbrella valve, the umbrella valve is configured to prevent air from venting from the filter core into the bottle.

9. The bottle of claim 8, wherein the diaphragm is in fluid communication with a channel of the filter core, and air is retained within the channel until the threshold pressure is applied to the diaphragm.

10. The bottle of claim 8, the bottle further including:
a cap coupled to a bottom portion of the filter core, the cap further including apertures; and
wherein the diaphragm seals the apertures of the cap when a pressure lower than the threshold pressure is applied to the diaphragm.

11. The bottle of claim 8, the bottle further including a filter adapter coupled at a first end to the lid and at a second end to a top portion of the filter core.

12. The bottle of claim 8, wherein when water is poured from the bottle, the filter core is configured to passively filter water via a gravitational force.

13. The bottle of claim 8, wherein the umbrella valve is configured to open when the threshold pressure is applied to the diaphragm.

14. The bottle of claim 8, wherein the filter core comprises activated carbon.

15. A free flow filter water bottle, the bottle comprising:
a body with an interior volume;
a filter core, the filter core positioned and located in the interior volume of the bottle; and
a valve including a diaphragm, the valve configured to impede a flow of air from the filter core into the interior of the bottle when the valve is in a closed position.

16. The bottle of claim 15, the bottle further including:
a cap coupled to a bottom portion of the filter core, the cap including at least one aperture; and
wherein, when the valve is in the closed position, the diaphragm abuts the cap and overlays the at least one aperture.

17. The bottle of claim 15, wherein when the threshold pressure is applied to the valve, the valve is in an open position.

18. The bottle of claim 17, wherein when the valve is in the open position, air exterior to the bottle is in fluid communication with an interior of the bottle.

19. The bottle of claim 15, the bottle further including a filter housing including a plurality of apertures extending through a surface of the filter housing, the plurality of apertures positioned and arranged such that the filter core is in fluid communication with the interior of the bottle.

20. The bottle of claim 15, wherein the bottle is adapted to passively filter water when water is poured from the bottle.
